(19) United States
(12) Patent Application Publication
(10) Pub. No.: US 2026/0332240 A1
(43) Pub. Date: Oct. 22, 2026

(54) ANTENNA BEAM STEERING METHOD AND APPARATUS FOR MOBILE SATELLITE COMMUNICATION

(71) Applicant: Google LLC, Mountain View, CA (US)

(72) Inventors: Ming Sun, Mountain View, CA (US); Niels Bonne Larsen, Mountain View, CA (US)

(21) Appl. No.: 18/853,629

(22) PCT Filed: Nov. 28, 2023
(86) PCT No.: PCT/US2023/081346

§ 371 Date: Oct. 2, 2024

(51) Int. Cl. H01Q 3/24; H01Q 1/38; H01Q 1/42; H01Q 9/27; H01Q 21/00

(52) U.S. Cl. CPC H04B 7/18513; H01Q 1/243; H01Q 3/24; H04B 1/0064; H04B 7/0617; H04W 88/06

(57) ABSTRACT

An example device comprising: a plurality of antennas; and one or more processors configured to: transmit, via a first antenna of the plurality of antennas and at a first time, a terrestrial communication signal; and transmit, via the plurality of antennas and at a second time, a non-terrestrial communication signal, wherein transmitting the non-terrestrial communication signal comprises forming a beam using at least two antennas of the plurality of antennas, the at least two antennas including the first antenna.

### BACKGROUND

Terrestrial communication offers transmission of information over land-based infrastructure, such as mobile networks located on the ground. For example, a mobile device may connect to a cell tower or a base station via radio waves. In situations where the physical infrastructure is not available (such as the middle of the ocean) terrestrial communication may not be available. As such, some mobile computing devices may communicate using non-terrestrial communication, such as satellite networks. Mobile computing devices capable of non-terrestrial communication may often be heavier, bulkier and have only the basic features of modern terrestrial mobile computing devices.

### SUMMARY

In general, aspects of this disclosure are directed to mobile computing devices that reuse at least two antennas of the plurality of antennas within the device. When using non-terrestrial communication, a mobile computing device may need a direct line-of-sight with a satellite. In particular, it may be desirable for a main lobe of a transmission from the mobile computing device to be pointed at the satellite. As such, some mobile computing devices may include one or more antennas specifically for non-terrestrial communication, and the mobile computing device may utilize the non-terrestrial antennas to form a beam directed at the satellite. However, the inclusion of the additional non-terrestrial antennas may not be desirable. For instance, the additional non-terrestrial antennas may occupy additional space within the mobile computing device, and/or increase a manufacturing cost of the mobile computing device.

In accordance with one or more aspects of this disclosure, a mobile computing device may utilize a particular antenna of a plurality of antennas for both terrestrial and non-terrestrial communication. For instance, the mobile computing device may, at a first time, communicate via terrestrial communication by a first antenna or at a second time the device may use the first antenna with at least one other antenna to form an array of antennas for non-terrestrial communication. As one example, the mobile computing device may use the array to transmit information by forming a beam directed at a satellite for non-terrestrial communication. In this way, aspects of the disclosure may improve non-terrestrial communication in mobile computing devices without occupying additional hardware space within the device.

In one example, a mobile computing device includes a plurality of antennas; and one or more processors configured to: transmit, via a first antenna of the plurality of antennas and at a first time, a terrestrial communication signal; and transmit, via the plurality of antennas and at a second time, a non-terrestrial communication signal, wherein transmitting the non-terrestrial communication signal comprises forming a beam using at least two antennas of the plurality of antennas, the at least two antennas including the first antenna.

In another example, a method includes transmitting, at a first time, via a first antenna within a device comprising a plurality of antennas, a terrestrial communication signal; and transmitting, at a second time, via the plurality of antennas, a non-terrestrial communication signal, wherein transmitting the non-terrestrial communication signal comprises forming a beam using at least two antennas of the plurality of antennas, the at least two antennas including the first antenna.

In another example, various aspects of the techniques are directed to a non-transitory computer-readable storage media having stored thereon instructions that, when executed, cause one or more processors to: transmit, via a first antenna of a plurality of antennas and at a first time, a terrestrial communication signal; and transmit, via the plurality of antennas and at a second time, a non-terrestrial communication signal, wherein transmitting the non-terrestrial communication signal comprises forming a beam using at least two antennas of the plurality of antennas, the at least two antennas including the first antenna.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

FIG. 1 is a conceptual diagram illustrating an example environment 100 for antenna beam steering for a mobile computing device 110, in accordance with one or more aspects of the present disclosure.

FIG. 2 is a conceptual diagram illustrating an example mobile computing device 210 that performs terrestrial and non-terrestrial communication, in accordance with one or more aspects of this disclosure.

FIGS. 3A and 3B are conceptual diagrams illustrating example terrestrial and non-terrestrial signal flows through computing device 310, in accordance with aspects of this disclosure.

FIGS. 4A and 4B are conceptual diagrams illustrating example terrestrial and non-terrestrial communication via mobile computing device 410 which includes antennas 416A and 416B, in accordance with aspects of this disclosure.

FIGS. 5A-5C are graphs illustrating various beams that may be formed by a mobile computing device performing non-terrestrial communication, in accordance with aspects of this disclosure.

FIG. 6 is a flowchart illustrating example operations of an example mobile computing device in accordance with one or more aspects of the present disclosure.

### DETAILED DESCRIPTION

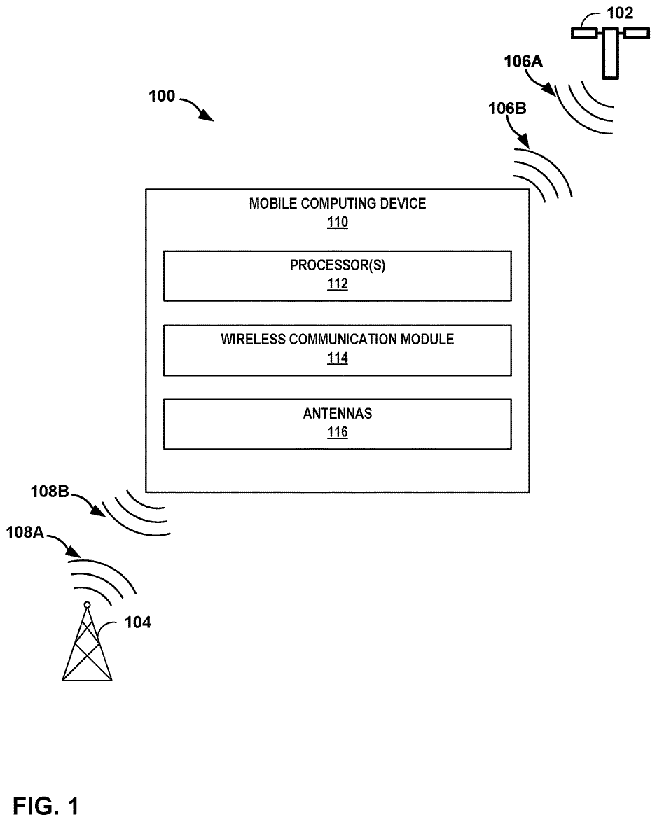

FIG. 1 is a conceptual diagram illustrating an example environment 100 for antenna beam steering for a mobile computing device 110, in accordance with one or more aspects of the present disclosure. Example environment 100 may include a satellite 102, a cell tower 104, and mobile computing device 110.

Satellite 102 may represent a non-terrestrial network that communicates with mobile computing device 110. For instance, satellite 102 may broadcasts signals 106A to mobile computing device 110 and/or receive signals 106B from mobile computing device 110. As such, satellite 102 may facilitate non-terrestrial communication. Satellite 102 may reside in any of low earth orbit, medium earth orbit, and geostationary orbit. In some examples, satellite 102 may be a high-altitude platform or a drone (e.g., a device not located on Earth's surface, thereby not being a terrestrial network component). Satellite 102 may be a sole satellite in a non-terrestrial network, or may be a particular satellite of a plurality of satellites that form a constellation of a non-terrestrial network. Non-terrestrial networks may bring coverage to remote areas that would typically not have terrestrial communication and/or areas in which terrestrial networks are not functioning or are otherwise obstructed.

Cell tower 104 may represent a terrestrial network that communicates with mobile computing device 110. For instance, cell tower 104 may broadcast signals 108A to mobile computing device 110 and/or receive signals 108B from mobile computing device 110. As such, cell tower 104 may facilitate terrestrial communication. Cell tower 104 may reside anywhere on Earth's surface. In some examples, cell tower 104 may be a base station and may be connected (e.g., via wired or wireless connection) to other components of the terrestrial network. Cell tower 104 may be a sole cell tower in a terrestrial network or may be a particular cell tower of a plurality of cell towers that form a terrestrial network. Terrestrial networks may bring coverage to areas where their physical infrastructure has been installed on the Earth's surface and is functioning properly and not obstructed.

Terrestrial and non-terrestrial communication may operate within a designated range of frequencies in the electromagnetic frequency spectrum known as a frequency band. Each frequency band may have a defined upper and lower limit. Examples of non-terrestrial frequency bands comprises the n255 and n256 bands. Examples of terrestrial frequency bands comprises the low frequency and medium frequency bands.

Mobile computing device 110 may be a portable device that includes components that are configured to communicate via terrestrial or non-terrestrial communication. As shown in FIG. 1, mobile computing device 110 may include one or more processors 112, wireless communication modules 114, and antennas 116. Examples of mobile computing device 110 include, but are not limited to, mobile phones, gaming devices, vehicles, tablets, cameras, laptops, wearable computing devices, e-book readers, etc.

Processors 112 may implement functionality and/or execute instructions within mobile computing device 110. Examples of processors 112 include, but are not limited to, one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein.

Wireless communication module 114 may include various components that receive signals and process them to generate one or more outputs to be passed to the antennas. For instance, the wireless communication module 114 may include one or more signal generators that produce terrestrial signal 108B or non-terrestrial signal 106A, one or more duplexers that allow for transmit and receive of non-terrestrial signals 106 without interference, one or more filters for terrestrial signals 108, one or more switches to route the signals 106A and 108A, and one or more antenna impedance tuners to adjust impedance and introduce a delay to the signal. In some examples, components of the wireless communication module 114 may exclusively process non-terrestrial signals 106 (e.g., satellite, drone, etc.). In other examples, components of the wireless communication module 114 may process other terrestrial signals 108 (e.g., cellular, Wi-Fi, etc.).

Antennas 116 may implement a transmit or receive signal functionality within a mobile computing device 110. Antennas 116 may include a plurality of antennas, which may be positioned at various locations of mobile computing device 110. Examples of antennas 116, include, but are not limited to, one or more dipole, monopole, Yagi, loop or patch antennas. Accordingly, the term “antenna,” as used herein may refer to any of the foregoing structures or any other structure suitable for implementation of the techniques described herein.

In some examples, antennas 116 may include separate antennas for terrestrial and non-terrestrial communication. In such cases, additional hardware may be required, and said additional hardware may occupy additional space within the already limited space of the mobile computing device 110. For instance, a satellite phone may be specifically designed for satellite non-terrestrial communication, with antennas just for that purpose, and is often bulkier, heavier and may perform only basic functionality as compared with a device that exclusively communicates via terrestrial communication. Additionally, computing devices that perform only non-terrestrial communication typically require the non-terrestrial antenna to be manually pointed at the satellite (e.g., by adjusting an orientation of the entirety of mobile computing device 110). However, requiring such positioning of mobile computing device 110 may be undesirable (e.g., users may not understand the direction in which to point, may ignore the need for pointing entirely, etc.). Therefore, it may be desirable to a mobile computing device to be able to perform both terrestrial and non-terrestrial communications without substantial additional hardware and with looser constraints on device orientation.

In accordance with one or more aspects of this disclosure, mobile computing device 110 may utilize a particular antenna of antennas 116 for both terrestrial and non-terrestrial communication. For instance, mobile computing device 110 may, at a first time, perform terrestrial communication via a first antenna of antennas 116 and then, at a second time, perform non-terrestrial communication via the first antenna and at least one other antenna of antennas 116. As such, mobile computing device 110 may reuse one or more antennas for both terrestrial and non-terrestrial communication, thereby avoiding the inclusion of at least some additional hardware. Furthermore, mobile computing device 110 may utilize beamforming when performing non-terrestrial communication. For instance, processors 112 may cause wireless communication module 114 to transmit signals 106B by forming a beam using an array that includes the first antenna and at least one additional antenna of antennas 116. By using beamforming for non-terrestrial communication, mobile computing device 110 may reduce or eliminate a need for a user of mobile computing device 110 to adjust an orientation of mobile computing device 110 to facilitate non-terrestrial communication. In this way, aspects of this disclosure may improve performance of non-terrestrial communication without occupying additional space within mobile computing device 110, and/or without increasing a manufacturing cost of mobile computing device 110.

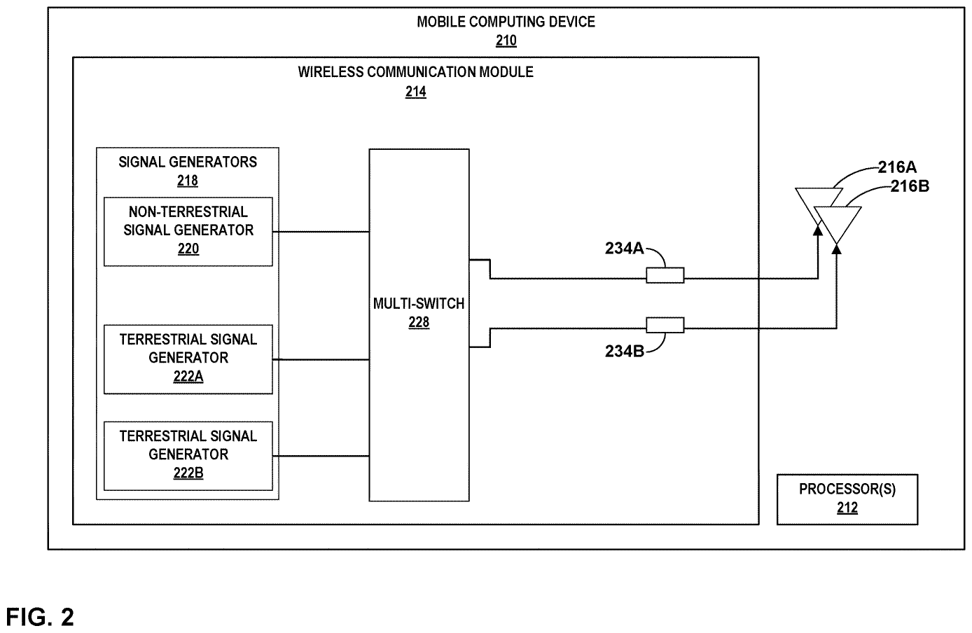

FIG. 2 is a conceptual diagram illustrating an example mobile computing device 210 that performs terrestrial and non-terrestrial communication, in accordance with one or more aspects of this disclosure. Mobile computing device 210 of FIG. 2 may be an example of mobile computing device 110 of FIG. 1. As shown in FIG. 2, mobile computing device 210 may include antennas 216A and 216B (collectively, “antennas 216”), processors 212, and wireless communication module 214. Similarly, processors 212, wireless communication module 214, and antennas 216 may respectively be examples of processors 112, wireless communication module 114, and antennas 116 of FIG. 1.

In the example of FIG. 2, processors 212, wireless communication module 214, and antennas 216 are illustrated as being within mobile computing device 210. For instance, processor 212 may control the wireless communication module 214 within the mobile computing device 210.

Similar to wireless communication module 114, wireless communication module 214 may include various components that generate and receive signals. As shown in FIG. 2, wireless communication module 214 may include signal generators 218 comprising non-terrestrial signal generator 220 and terrestrial signal generators 222A and 222B (collectively, “terrestrial signal generators 222”), multi-switch 228 and antenna impedance tuners 234A and 234B (collectively, “antenna impedance tuners 234”).

For instance, signal generators 218 may provide terrestrial or non-terrestrial signals to multi-switch 228. Non-terrestrial signal generator 220 may generate non-terrestrial signals from the n255 and n256 frequency band while the terrestrial signal generators may generate terrestrial signals from the low frequency and medium frequency bands. Terrestrial signal generator 222A may generate terrestrial signals independently of terrestrial signal generator 222B and vice versa.

Multi-switch 228 may be positioned logically between signal generators 218 and antenna impedance tuners 234 (e.g., logically between signal generators 218 and antennas 216) and multiplex signals between antenna impedance tuners 234 and signal generators 218. Antenna impedance tuners 234 may adjust impedances (e.g., based on control signals received from processors 212) for either terrestrial or non-terrestrial communication.

As noted above, processor 212 may control the wireless communication module to either produce terrestrial or non-terrestrial communications (e.g., respectively with either cell tower 104 or satellite 102). In some examples, processor 212 may control the wireless communication module to perform non-terrestrial communication by forming a beam using an array that includes the first antenna and at least one additional antenna of antennas 216. For instance, the beam may be directed at a desired angle by processor 212 configuring the antenna impedance tuners 234 to provide various impedance and phase delays between signal generators 218 and antennas 216.

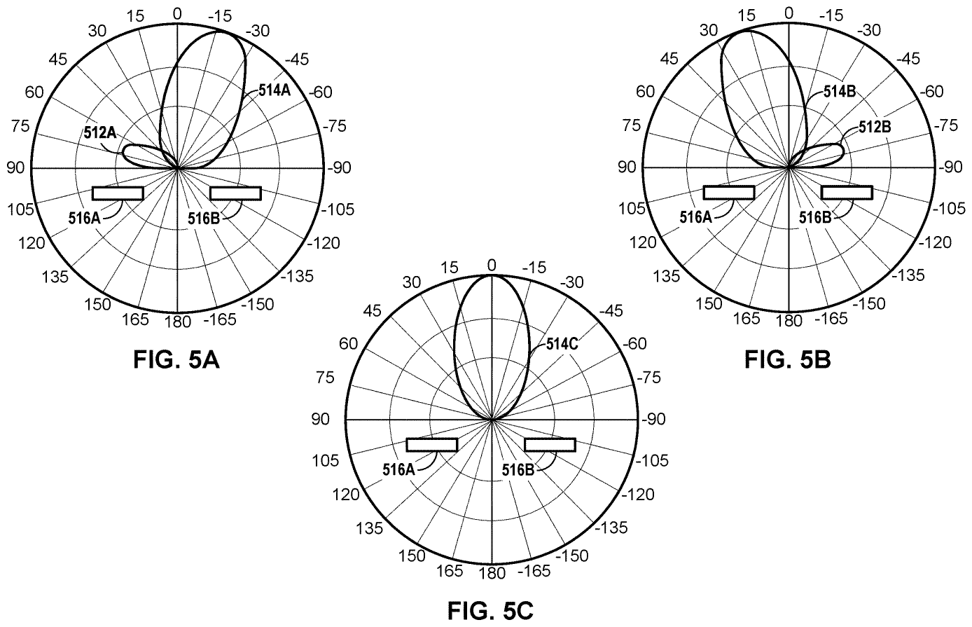

Typically, in an array of antennas where each antenna is transmitting the same signal, the signals of the individual antennas in the array will constructively and destructively interfere to form a beam in one specific direction. However, if a phase delay is applied to each of the signals of the individual antennas the direction in which the signals form the beam will change, thus enabling the beam to be steered in a desired direction. As discussed above and in further detail with reference to FIGS. 5A-5C, processor 212 may control antenna impedance tuners 234 to selectively introduce delay, enabling steering of a resulting beam emitted by antennas 216.

In some examples for non-terrestrial communication, the processor 212 may monitor a downlink signal received signal strength indicator and its corresponding angle. The processor 212 may then steer a beam formed for an uplink signal based on the direction and angle of the received signal strength indicator.

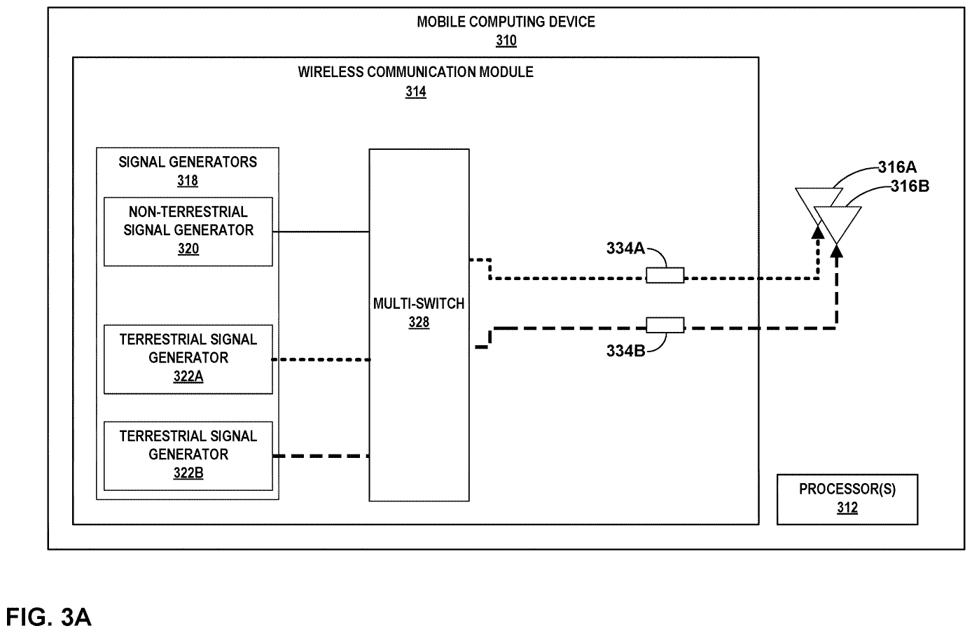

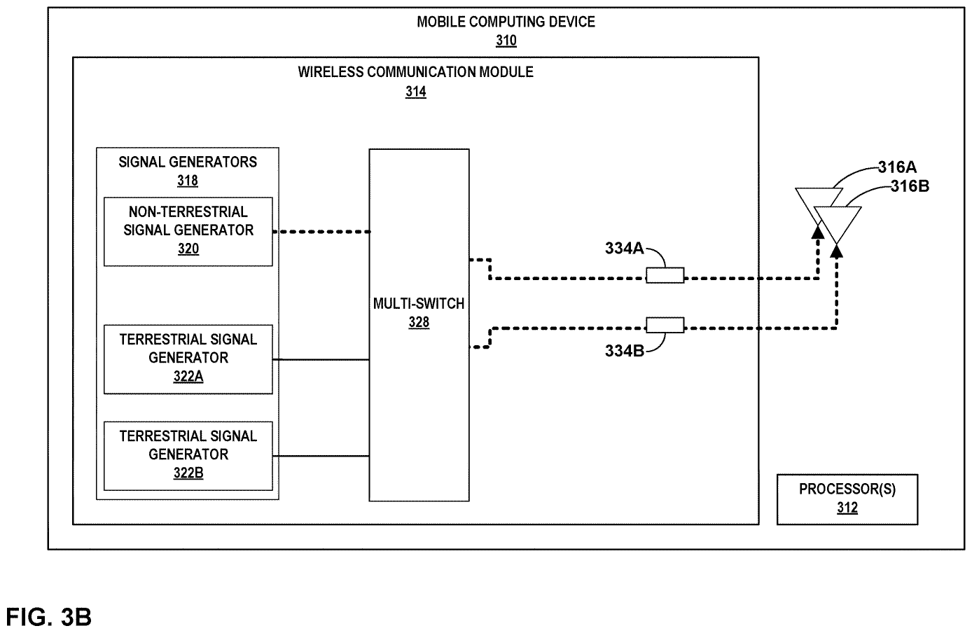

FIGS. 3A and 3B are conceptual diagrams illustrating example non-terrestrial and terrestrial signal flows through computing device 310, in accordance with aspects of this disclosure. Mobile computing device 310 of FIGS. 3A and 3B is an example of mobile computing device 210 of FIG. 2. FIG. 3A illustrates an example signal flow for terrestrial communication and FIG. 3B illustrates an example signal flow for non-terrestrial communication.

As shown in FIG. 3A processors 312 may control signal generators 318 to generate terrestrial signals via terrestrial signal generators 322. The terrestrial signals generated by 322 may be independent signals and processor 312 may independently configured antennas 316 to transmit each signal. The multi-switch 328 may route each terrestrial signal to a respective antenna impedance tuner 334 which may then pass each signal individually to an antenna of antennas 316 for transmission. For instance, antenna 316A at a first time may transmit a first terrestrial signal and at a second time antenna 316B may transmit a second terrestrial signal.

As shown in FIG. 3B processors 312 may control signal generators 318 to generate a non-terrestrial signal via non-terrestrial signal generator 320. The multi-switch may split the non-terrestrial signal into two signals (e.g., two identical signals) and route each signal through antenna impedance tuners 334 which may selectively apply a phase delay to the signals (e.g., processors 312 may selectively adjust the delay to change an angle of a resulting beam). The signals may then be passed to the antennas 316 which may form an array of antennas to generate a beam at a desired direction to transmit the signal to the non-terrestrial network (e.g., a satellite).

In accordance with one or more aspects of this disclosure the mobile computing device 310 may utilize a particular antenna of antennas 316 for both terrestrial and non-terrestrial communication. For instance, the mobile computing device 310 may, at a first time, communicate via terrestrial communication by a first antenna 316A or at a second time the device may use the first antenna 316A with at least one other antenna 316B to form an array of antennas for non-terrestrial communication. As one example, the mobile computing device 310 may use the array to transmit information by forming a beam directed at a satellite 102 for non-terrestrial communication. In this way, aspects of the disclosure may improve non-terrestrial communication in mobile computing devices without occupying additional hardware space within the device.

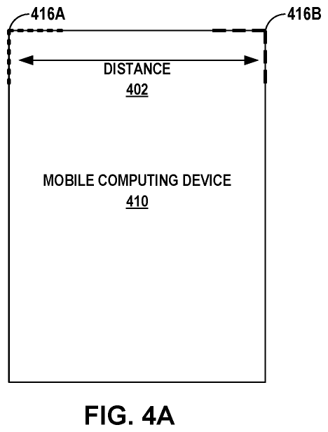

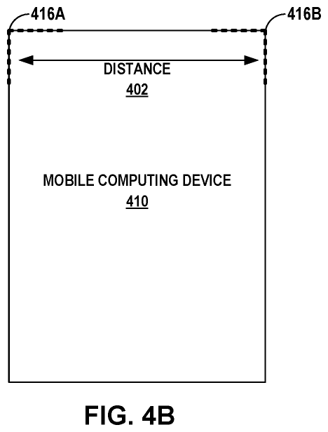

FIGS. 4A and 4B are conceptual diagrams illustrating example terrestrial and non-terrestrial communication via mobile computing device 410 which includes antennas 416A and 416B, in accordance with aspects of this disclosure. Mobile computing device 410 of FIGS. 4A and 4B is an example of mobile computing device 310 of FIGS. 3A and 3B. FIG. 4A illustrates an example of antennas 416A and 416B independently configured to transmit separate signals via terrestrial communication. The independent configurations of antennas 416A and 416B in FIG. 4A may be similar or the same as the independent configurations of antennas 316A and 316B in FIG. 3A. FIG. 4B illustrates an example of antennas 416A and 416B configured to form a beam to transmit non-terrestrial signals. The configurations of antennas 416A and 416B in FIG. 4B may be similar or the same as the configurations of antennas 316A and 316B in FIG. 3B.

A distance between antennas 402 may be selected based on a wavelength of a transmitted signal. For instance, the distance between the two antennas 402 within the mobile computing device 410 is about (e.g., +/−5%) 0.5*wavelength of the transmitted signal to about 0.8*wavelength of the transmitted signal. As one specific example, when designing a device to transmit in the n255 band, which has a frequency of 1645 MHz and a corresponding wavelength of 18.22 cm, the distance between antennas 402 may be between about 9.11 cm to 14.57 cm.

FIGS. 5A-5C are graphs illustrating various beams that may be formed by a mobile computing device performing non-terrestrial communication, in accordance with aspects of this disclosure. The beams shown in FIGS. 5A-5C may be formed by a computing device, such as computing device 400 of FIGS. 4A and 4B, that includes antennas 516A and 516B (collectively, “antennas 516”) that may be similar to antennas 416A and 416B in FIGS. 4A and 4B. Each of FIGS. 5A-5C illustrates an emission from antennas 516 having a respective main lobe of main lobes 514A-514C, FIGS. 5A and 5B also include respective side lobes of side lobes 512A and 512B.

As shown in FIG. 5A, antennas 516 may be driven with phase delayed signals to cause main lobe 514A to be pointed 25 degrees to the right (e.g., emission of the signal by antenna 516B may be delayed relative to emission of the signal by antenna 516A). As shown in FIG. 5B, antennas 516 may be driven with phase delayed signals to cause main lobe 514B to be pointed 25 degrees to the left (e.g., emission of the signal by antenna 516A may be delayed relative to emission of the signal by antenna 516B). As shown in FIG. 5C, antennas 516 may be driven with similar or non-phase delayed signals to cause main lobe 514C to be pointed perpendicular to antennas 516.

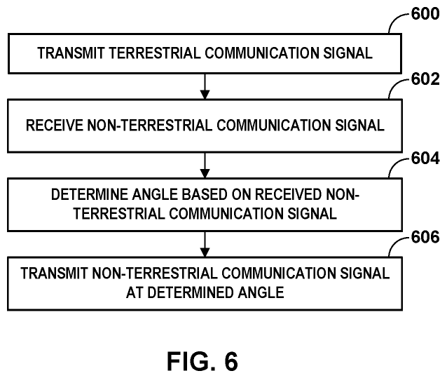

FIG. 6 is a flowchart illustrating example operations of an example mobile computing device in accordance with one or more aspects of the present disclosure. Although the example operation of FIG. 6 is described as being performed by mobile computing device 110 of FIG. 1, in other examples some or all of the example operations may be performed by another computing device.

Mobile computing device 110 may transmit a terrestrial communication signal to a terrestrial network device (e.g., cell tower 104) using at least a first antenna of antennas 116 (600).

Processor 112 may configure the mobile computing device 110 for either terrestrial (e.g., cell tower 104) or non-terrestrial (e.g., satellite 102) communication. For instance, after mobile computing device 110 transmits a terrestrial communication signal the processor 112 may configure the mobile computing device to receive non-terrestrial communication signals using the first antenna and at least one additional antenna of antennas 116 (602).

In accordance with one or more aspects of this disclosure, mobile computing device 110 may utilize a particular antenna of antennas 116 for both terrestrial and non-terrestrial communication. For instance, mobile computing device 110 may, at a first time, perform terrestrial communication via a first antenna of antennas 116 and then, at a second time, perform non-terrestrial communication via the first antenna and at least one other antenna of antennas 116. As such, mobile computing device 110 may reuse one or more antennas for both terrestrial and non-terrestrial communication. It is understood that the first time may occur before or after the second time.

In some examples after receiving a non-terrestrial communication signal and before transmitting a non-terrestrial communication signal, the processor 112 may monitor a downlink signal received signal strength indicator and its corresponding angle to determine an angle for transmission of the non-terrestrial signal (604).

The processor 112 may control antenna impedance tuners 234 to selectively introduce delay, enabling steering of a resulting beam emitted by antennas 116 for non-terrestrial communication. The processor 112 using beam steering, may then transmit a non-terrestrial communication signal at the determined angle (606).

Aspects of this disclosure include the following examples.

Example 1. A device comprising: a plurality of antennas; and one or more processors configured to: transmit, via a first antenna of the plurality of antennas and at a first time, a terrestrial communication signal; and transmit, via the plurality of antennas and at a second time, a non-terrestrial communication signal, wherein transmitting the non-terrestrial communication signal comprises forming a beam using at least two antennas of the plurality of antennas, the at least two antennas including the first antenna.

Example 2. The device of example 1, wherein the one or more processors are further configured to: monitor a downlink signal received signal strength indicator and a corresponding angle, wherein, to transmit the non-terrestrial communication signal, the one or more processors are configured to: form, with an angle determined based on the downlink signal received signal strength indicator and the corresponding angle, the beam.

Example 3. The device of example 1, further comprising: a signal generator; a first impedance tuner connected between the signal generator and the first antenna; and a second impedance tuner connected between the signal generator and a second antenna of the two or more antennas, wherein, to form the beam using at least the two antennas, the one or more processors control one or both of the first impedance tuner and the second impedance tuner to introduce a delay in a particular signal output by the signal generator.

Example 4. The device of example 3, wherein the signal generator is a non-terrestrial signal generator of a plurality of signal generators, the device further comprising: a terrestrial signal generator of the plurality of signal generators; and a switch connected to the terrestrial signal generator and the non-terrestrial signal generator, wherein the switch is electrically positioned between the plurality of signal generators and the two or more antennas.

Example 5. The device of example 4, wherein the terrestrial signal generator is a first terrestrial signal generator, wherein the plurality of signal generators further comprises a second terrestrial signal generator, wherein, to transmit the terrestrial communication signal via the first antenna at the first time, the one or more processors are configured to cause, at the first time, the switch to connect the first terrestrial signal generator to the first antenna, and wherein the one or more processors are further configured to: transmit, via the second antenna and at the first time, a second terrestrial communication signal that is different than the first terrestrial communication signal, wherein to transmit the second terrestrial communication signal, the one or more processors are configured to cause, at the first time, the switch to connect the second terrestrial signal generator to the second antenna.

Example 6. The device of example 1, The device of any of claims 1-5, wherein a distance between the first antenna and a second antenna of the at least two antennas is within a range from about 0.5*wavelength of the non-terrestrial communication signal to 0.8*wavelength of the non-terrestrial communication signal.

Example 7. The device of example 1, wherein: to transmit the non-terrestrial communication signal, the one or more processors transmit the non-terrestrial communication signal in a n255 frequency band, and to transmit the terrestrial communication signal, the one or more processors transmit the terrestrial communication signal in a cellular band.

Example 8. A method comprising: transmitting, at a first time, via a first antenna within a device comprising a plurality of antennas, a terrestrial communication signal; and transmitting, at a second time, via the plurality of antennas, a non-terrestrial communication signal, wherein transmitting the non-terrestrial communication signal comprises forming a beam using at least two antennas of the plurality of antennas, the at least two antennas including the first antenna.

Example 9. The method of example 8, further comprising one or more processors: monitoring a downlink signal received signal strength indicator and a corresponding angle, transmitting, the non-terrestrial communication signal by forming, with an angle determined based on the downlink signal received signal strength indicator and the corresponding angle, the beam.

Example 10. The method of example 8, further comprising: a signal generator; a first impedance tuner connected between the signal generator and the first antenna; and a second impedance tuner connected between the signal generator and a second antenna of the two or more antennas, wherein, to form the beam using at least the two antennas, the one or more processors control one or both of the first impedance tuner and the second impedance tuner to introduce a delay in a particular signal output by the signal generator.

Example 11. The method of example 10, wherein the signal generator is a non-terrestrial signal generator of a plurality of signal generators further comprising: a terrestrial signal generator of the plurality of signal generators; and a switch connected to the terrestrial signal generator and the non-terrestrial signal generator, wherein the switch is electrically positioned between the plurality of signal generators and the two or more antennas.

Example 12. The method of example 11, wherein the terrestrial signal generator is a first terrestrial signal generator, wherein the plurality of signal generators further comprises a second terrestrial signal generator, and wherein transmitting the terrestrial communication signal via the first antenna at the first time comprises the switch connecting the first terrestrial signal generator to the first antenna, and further comprises: transmitting, via the second antenna and at the first time, a second terrestrial communication signal that is different than the first terrestrial communication signal, wherein to transmit the second terrestrial communication signal comprises, at the first time, the switch connecting the second terrestrial signal generator to the second antenna.

Example 13. The method of example 8, wherein a distance between the first antenna and a second antenna of the at least two antennas is within a range from about 0.5*wavelength of the non-terrestrial communication signal to 0.8*wavelength of the non-terrestrial communication signal.

Example 14. The method of example 8, further comprising: transmitting the non-terrestrial communication signal in a n255 frequency band, and transmitting the terrestrial communication signal in a cellular band.

Example 15. A non-transitory computer-readable storage media having stored thereon instructions that, when executed, cause one or more processors to: transmit, via a first antenna of a plurality of antennas and at a first time, a terrestrial communication signal; and transmit, via the plurality of antennas and at a second time, a non-terrestrial communication signal, wherein transmitting the non-terrestrial communication signal comprises forming a beam using at least two antennas of the plurality of antennas, the at least two antennas including the first antenna.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples of the disclosure have been described. Any combination of the described systems, operations, or functions is contemplated. These and other examples are within the scope of the following claims

1: A device comprising:
a plurality of antennas; and
one or more processors configured to:
transmit, via a first antenna of the plurality of antennas and at a first time, a terrestrial communication signal; and
transmit, via the plurality of antennas and at a second time, a non-terrestrial communication signal, wherein transmitting the non-terrestrial communication signal comprises forming a beam using at least two antennas of the plurality of antennas, the at least two antennas including the first antenna.

2: The device of claim 1, wherein the one or more processors are further configured to:
monitor a downlink signal received signal strength indicator and a corresponding angle, wherein, to transmit the non-terrestrial communication signal, the one or more processors are configured to:
form, with an angle determined based on the downlink signal received signal strength indicator and the corresponding angle, the beam.

3: The device of claim 1, further comprising:
a signal generator;
a first impedance tuner connected between the signal generator and the first antenna; and a second impedance tuner connected between the signal generator and a second antenna of the at least two antennas,
wherein, to form the beam using at least the two antennas, the one or more processors control one or both of the first impedance tuner and the second impedance tuner to introduce a delay in a particular signal output by the signal generator.

4: The device of claim 3, wherein the signal generator is a non-terrestrial signal generator of a plurality of signal generators, the device further comprising:
a terrestrial signal generator of the plurality of signal generators; and
a switch connected to the terrestrial signal generator and the non-terrestrial signal generator, wherein the switch is electrically positioned between the plurality of signal generators and the at least two antennas.

5: The device of claim 4, wherein the terrestrial signal generator is a first terrestrial signal generator, wherein the terrestrial communication signal is a first terrestrial communication signal, wherein the plurality of signal generators further comprises a second terrestrial signal generator, wherein, to transmit the terrestrial communication signal via the first antenna at the first time, the one or more processors are configured to cause, at the first time, the switch to connect the first terrestrial signal generator to the first antenna, and wherein the one or more processors are further configured to:
transmit, via the second antenna and at the first time, a second terrestrial communication signal that is different than the first terrestrial communication signal, wherein to transmit the second terrestrial communication signal, the one or more processors are configured to cause, at the first time, the switch to connect the second terrestrial signal generator to the second antenna.

6: The device of claim 1, wherein a distance between the first antenna and a second antenna of the at least two antennas is within a range from about 0.5*wavelength of the non-terrestrial communication signal to 0.8*wavelength of the non-terrestrial communication signal.

7: The device of claim 1, wherein:
to transmit the non-terrestrial communication signal, the one or more processors transmit the non-terrestrial communication signal in a n255 frequency band, and
to transmit the terrestrial communication signal, the one or more processors transmit the terrestrial communication signal in a cellular band.

8: A method comprising:
transmitting, at a first time, via a first antenna within a device comprising a plurality of antennas, a terrestrial communication signal; and
transmitting, at a second time, via the plurality of antennas, a non-terrestrial communication signal, wherein transmitting the non-terrestrial communication signal comprises forming a beam using at least two antennas of the plurality of antennas, the at least two antennas including the first antenna.

9: The method of claim 8, further comprising one or more processors:
monitoring a downlink signal received signal strength indicator and a corresponding angle,
transmitting, the non-terrestrial communication signal by forming, with an angle determined based on the downlink signal received signal strength indicator and the corresponding angle, the beam.

10: The method of claim 8, wherein the device comprises:
a signal generator;
a first impedance tuner connected between the signal generator and the first antenna; and a second impedance tuner connected between the signal generator and a second antenna of the at least two antennas,
wherein forming the beam using the at least the two antennas comprises controlling one or both of the first impedance tuner and the second impedance tuner to introduce a delay in a particular signal output by the signal generator.

11: The method of claim 10, wherein the signal generator is a non-terrestrial signal generator of a plurality of signal generators further comprising:
a terrestrial signal generator of the plurality of signal generators; and
a switch connected to the terrestrial signal generator and the non-terrestrial signal generator, wherein the switch is electrically positioned between the plurality of signal generators and the at least two antennas.

12: The method of claim 11,
wherein the terrestrial signal generator is a first terrestrial signal generator,
wherein the terrestrial communication signal is a first terrestrial communication signal,
wherein the plurality of signal generators further comprises a second terrestrial signal generator, and
wherein transmitting the terrestrial communication signal via the first antenna at the first time comprises connecting, via the switch, the first terrestrial signal generator to the first antenna, and further comprises:
transmitting, via the second antenna and at the first time, a second terrestrial communication signal that is different than the first terrestrial communication signal, wherein transmitting the second terrestrial communication signal comprises connecting, at the first time and via the switch, the second terrestrial signal generator to the second antenna.

13: The method of claim 8, wherein a distance between the first antenna and a second antenna of the at least two antennas is within a range from about 0.5*wavelength of the non-terrestrial communication signal to 0.8*wavelength of the non-terrestrial communication signal.

14: The method of claim 8, further comprising:
transmitting the non-terrestrial communication signal in a n255 frequency band, and
transmitting the terrestrial communication signal in a cellular band.

15: A non-transitory computer-readable storage media having stored thereon instructions that, when executed, cause one or more processors to:
transmit, via a first antenna of a plurality of antennas and at a first time, a terrestrial communication signal; and
transmit, via the plurality of antennas and at a second time, a non-terrestrial communication signal, wherein transmitting the non-terrestrial communication signal comprises forming a beam using at least two antennas of the plurality of antennas, the at least two antennas including the first antenna.

16: The computer-readable storage media of claim 15, further comprising instructions that cause the one or more processors to:
monitor a downlink signal received signal strength indicator and a corresponding angle,
transmit the non-terrestrial communication signal by forming, with an angle determined based on the downlink signal received signal strength indicator and the corresponding angle, the beam.

17: The computer-readable storage media of claim 15, wherein:
the instructions that cause the one or more processors to transmit the non-terrestrial communication signal comprise instructions that cause the one or more processors to transmit the non-terrestrial communication signal in a n255 frequency band, and
the instructions that cause the one or more processors to transmit the terrestrial communication signal comprise instructions that cause the one or more processors to transmit the terrestrial communication signal in a cellular band.
